(19) United States
(12) Patent Application Publication
(10) Pub. No.: US 2024/0132265 A1
(43) Pub. Date: Apr. 25, 2024

(54) MULTILAYER COVER ELEMENTS FOR SEALING CAPSULES FOR MAKING BEVERAGES

(71) Applicant: Goglio S.p.A., Milano (MI) (IT)

(72) Inventors: Franco GOGLIO, Milano (MI) (IT); Osvaldo BOSETTI, Milano (MI) (IT); Roberto GALBASINI, Milano (MI) (IT); Andrea MACCAGNAN, Milano (MI) (IT)

(21) Appl. No.: 17/769,605

(22) PCT Filed: Oct. 13, 2020
(86) PCT No.: PCT/IB2020/059648

§ 371 Date: Apr. 14, 2022

(30) Foreign Application Priority Data
Oct. 17, 2019 (IT) 102019000019355

(51) Int. Cl. B65D 65/46; B65D 85/804

(52) U.S. Cl. CPC B65D 65/466; B65D 85/8043

(57) ABSTRACT

A cover element for sealing capsules for use in making brewed beverages may include: a main layer having an inner surface configured to face a housing zone of a capsule for making the brewed beverages and having an outer surface that faces away from the inner surface, wherein the main layer is made of compostable material; a protective layer overlying the outer surface of the main layer; a waterproof layer, applied on the inner surface of the main layer and including at least one metallic layer; and a filtering layer underlying the inner surface of the main layer. The main layer may have a plurality of lines of weakness formed at least on the outer surface. The waterproof layer may be free of lines of weakness. The filtering layer may be free of lines of weakness.

The present invention relates to a cover element for capsules for use in making brewed beverages. This cover element is specifically adapted to close capsules adapted to be introduced into automatic and semi-automatic beverage-making machines. By way of example, the capsules comprising the cover element of the present invention are adapted for use in making beverages such as coffee, tea, milk, chocolate, herbal teas and infusions in general.

A cover element for capsules for use in making brewed beverages is known in the art. This cover element is designed to seal a capsule having a housing zone, which is filled with a preparation for making beverages, such as for example coffee grounds.

The cover element comprises a main layer having an inner surface adapted to face a housing zone of a capsule for making brewed beverages. The cover element further has an outer surface opposite to the inner surface.

A protective layer overlies the outer surface of the main layer. A filtering layer underlies the inner surface of the main layer.

The inventors noted the disadvantage that the capsules with an element of known type do not work properly, especially at high humidity.

For example, in a particular machine model, water delivery pressure during beverage dispensing was found to reach a value of 18 bar with the known cover element still unbroken. In this case, the pump blocks, and the beverage is not dispensed. In other cases, the capsule may open at pressures above 12 bar, thus extending the dispensing times. In the worst cases, partial dispensing may occur or the pump blocks.

The inventors have found that, for normal operation, the capsule may be opened at pressures of less than 12 bar and, during dispensing, the pressure must rise to 18 bar for optimal dispensing of the beverage.

US 2017158422 and WO 2018083564 disclose examples of cover elements having cuts to facilitate rupture.

US 2017158422 provides cuts that also reach the filtering layer.

In the case of WO 2018083564, a metallic waterproof layer may be provided, which is the outermost or innermost of all, and at least partially receives the cuts in its thickness. The preferred examples as described above show cuts that extend at least partially through all the layers.

### SUMMARY OF THE INVENTION

Therefore, the technical purpose of the present invention is to provide a cover element for sealing capsules for use in making brewed beverages that can obviate the aforementioned prior art drawbacks.

Specifically, an object of the present invention is to provide a cover element for sealing capsules for use in making brewed beverages capable of reliably breaking during beverage dispensing when exposed to a predetermined pressure.

The aforementioned technical purpose and objects are substantially fulfilled by a cover element for sealing capsules for use in making brewed beverages, that comprises the technical features as disclosed in one or more of the accompanying claims.

In particular, a covering element for sealing capsules for use in making brewed beverages according to the present invention comprises a main layer. This main layer has an inner surface adapted to face a housing zone of a capsule for making brewed beverages. The main layer further has an outer surface opposite to the inner surface. The main layer is made of a compostable material.

A protective layer overlies the outer surface of the main layer.

A filtering layer underlies the inner surface of the main layer.

At least the main layer has a plurality of lines of weakness formed on at least one of the inner or outer surfaces.

This cover element solves the technical problem, as the lines of weakness are calibrated to break under a predetermined pressure, and allow proper dispensing of the beverage.

In the preferred embodiment, a waterproof layer, which comprises at least one metallic layer, is arranged between the main layer and the filtering layer. The waterproof layer and the filtering layer are free of lines of weakness. Therefore, until dispensing occurs, the capsule is properly sealed. Upon breaking, the filtering layer is in any case in a protected position with respect to the lines of weakness due to the presence of the waterproof layer. Therefore, dispensing may advantageously occur without requiring the filtering layer to be also broken, and allowing it to properly accomplish its filtering functions.

### LIST OF DRAWINGS

Further features and advantages of the present invention will result more clearly from the illustrative, non-limiting description of a preferred, non-exclusive embodiment of a cover element for sealing capsules for use in making brewed beverages as shown in the accompanying drawings, in which:

FIG. 1 is a schematic sectional view of a first embodiment of a cover element for sealing capsules for use in making brewed beverages according to the present invention;

FIG. 2 is a schematic sectional view of a second embodiment of a cover element for sealing capsules for use in making brewed beverages according to the present invention; and

FIG. 3 is a schematic sectional side view of a capsule for use in making brewed beverages.

### DETAILED DESCRIPTION

Referring to the accompanying figures, numeral 1 designates a cover element of the present invention. The cover element 1 is adapted to be applied to a capsule 100 for use in making brewed beverages. In particular, the cover element 1 is adapted to seal a capsule 100.

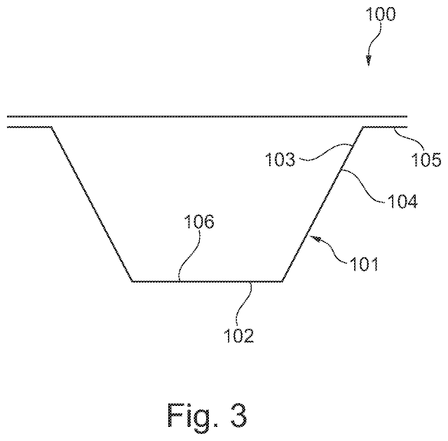

By way of example, a capsule 100 is schematically shown in FIG. 3. This capsule 100 comprises an enclosure 101, preferably made of compostable material. A housing zone 106, having an opening 103 is defined in the enclosure 101. This enclosure 101 is generally frustoconical in shape and has a bottom 102.

The aforementioned opening 103 is opposite to the bottom 102. The enclosure 101 comprises a side wall 104, converging from the opening 103 toward the bottom 102. A flange 105 is provided at the opening 103. A preparation, for example in powder form, for making brewed drinks is generally placed inside the housing zone 106.

In operation, the cover element 1 of the present invention is arranged to close the aforementioned opening 103. The cover element 1 comprises a main layer 2, in particular made of a compostable material. This main layer 2 has an inner surface 2a which, in operation, faces the housing zone 106. An outer surface 2b is opposite to the inner surface 2a. The main layer 2 at least partially defines a bearing structure of the cover element 1. Furthermore, the main layer 2 is made of a compostable material, preferably cellophane.

Additional layers are joined to the main layer 2, and will be described in detail hereinunder. For this purpose, the position of these layers will be identified with respect to the main layer 2 by the terms “above” and “below”. Such terms shall not be understood as limiting the orientation of either the cover element 1 or the capsule 100, which may be any orientation. Conversely, these terms are only used for the sake of simplicity and more comprehensive description. As used herein, the term “below” is used to identify a direction and/or a position from the cover element 1 toward the interior of the capsule 100, and the term “above” is used to indicate a direction from the cover element 1 toward the outside environment.

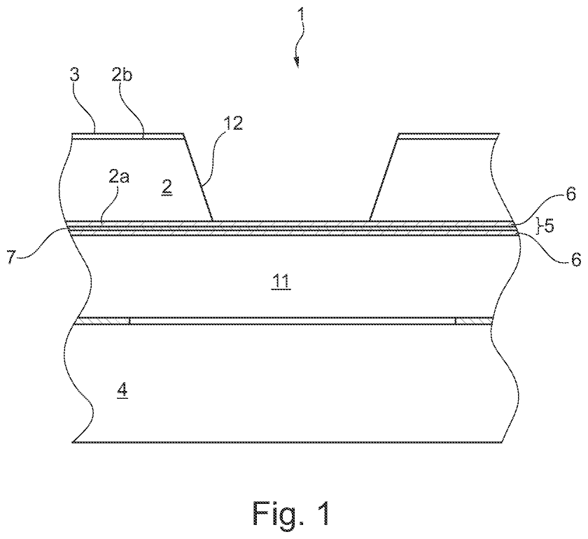

More in detail, a protective layer 3 overlies the outer surface 2b of the main layer 2. This protective layer 3 is particularly defined by lacquer, and directly faces the outer environment. It should be noted that, in the embodiment as shown in FIG. 1, the protective layer 3 is applied directly at the outer surface 2b of the main layer 2. Preferably, the protective layer 3 is defined by a lacquer that is well-known to the skilled person, and will not be further described herein.

A filtering layer 4 underlies the inner surface 2a of the main layer 2. This filtering layer 4 has the purpose to hold the content of the capsule 100 and prevent it from escaping as the beverage is being dispensed. In both the illustrated embodiments, the filtering layer 4 directly faces the housing zone 106 located inside the capsule 100. This filtering layer 4 may be made of any food-grade material that is known to the skilled person, by way of example PLA nonwoven.

In order to prevent moisture ingress into the capsule 100, the cover element 1 is provided with a waterproof layer 5. As shown for example in FIG. 1, the waterproof layer may be defined by a pair of metallic layers 6 bonded together by an adhesive layer 7. In this case, the waterproof layer 5 is applied to the inner surface 2a of the main layer 2.

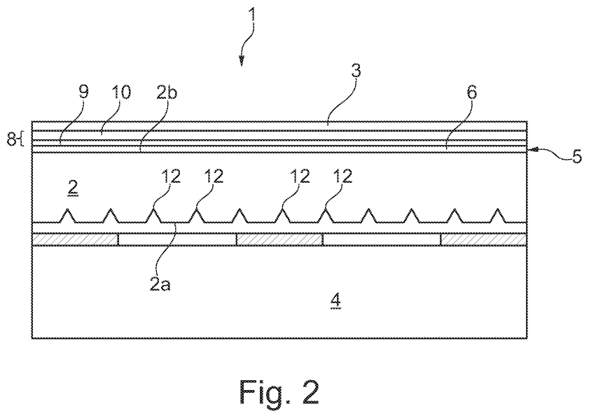

In the embodiment as shown in FIG. 2, the waterproof layer 5 is defined by a single metallic layer 6 directly applied on the outer surface 2b of the main layer 2.

In both cases, the metallic layers 6 may be made of aluminum and/or aluminum oxide and/or silicon oxide.

Optionally, the cover element has a molded coating 8. As shown in FIG. 2, this molded coating 8 comprises a primer layer 9 overlying the waterproof layer 5. An ink layer 10 is arranged between the primer layer 9 and the protective layer 3.

Optionally, as shown for example in FIG. 1, the cover element may comprise a reinforcing layer 11 arranged between the inner surface 2a of the main layer 2 and the filtering layer 4. The structural functions of the reinforcing layer 11 are similar to those of the main layer 2. As a result, the reinforcing layer 11 is also made of cellophane.

According to the present invention, at least the main layer 2 has a plurality of lines of weakness 12 formed on at least one of the surfaces 2a, 2b. These lines of weakness 12 are in such arrangement as to allow the main layer 22 to break when a pressure at the inner surface 2a reaches a value ranging from 5 to 15 bar, preferably 10 bar.

It should be noted that, in the embodiment as shown in FIG. 2, the lines of weakness 12 are formed on the inner surface 2a of the main layer 2. Alternatively, the lines of weakness 12 may be formed on the outer surface 2b of the main layer 2. Finally, as shown in the embodiment of FIG. 1, the lines of weakness 12 may extend throughout the thickness of the main layer 2.

It should be noted that the lines of weakness 12 may have a variable depth according to the material and thickness of the main layer 2 and more generally the composition of the cover element 1. Preferably, the lines of weakness 12 penetrate the main layer 2 to a length that ranges from 50% to 100%, preferably 80% of the thickness of the main layer 2.

It shall be noted that, in the embodiment of FIG. 2, the lines of weakness 12 are defined by notches formed on the main layer 2 by mechanical material removal.

Alternatively, as shown in FIG. 1, the lines of weakness 12 are defined by cuts formed by thermal ablation, preferably by means of a laser.

It should be noted that, in the embodiment as shown in FIG. 1, the lines of weakness 12 extend through the protective layer 3. This will not affect the seal of the capsule 100, since the underlying area, in particular the waterproof layer 5, remains intact. In this connection, it should be noted that in the embodiment of FIG. 1 the reinforcing layer 11 has no lines of weakness 12. There are no lines of weakness also in the filtering layer 4.

As shown in FIG. 1, the waterproofing layer 5 arranged between the inner surface 2a of the main layer 2 and the filtering layer 4, and more specifically between the main layer 2 and the reinforcing layer 11, separates a group of layers with the lines of weakness 12, i.e. the main layer 2 and the protective layer 3, from a group of layers without lines of weakness 12, i.e. the waterproof layer 5 itself, the reinforcing layer 11 and the filtering layer 4.

It shall be noted that all the layers 2, 3, 4, 5, 8, 11 are advantageously made of compatible materials or, alternatively, of materials compatible with a composting process.

1-13. (canceled)

14. A cover element for sealing capsules for use in making brewed beverages, the cover element comprising:
a main layer having an inner surface configured to face a housing zone of a capsule for making the brewed beverages and having an outer surface that faces away from the inner surface, wherein the main layer is made of compostable material;
a protective layer overlying the outer surface of the main layer;
a waterproof layer, applied on the inner surface of the main layer and comprising at least one metallic layer; and
a filtering layer underlying the inner surface of the main layer;
wherein the main layer has a plurality of lines of weakness formed at least on the outer surface,
wherein the waterproof layer is free of lines of weakness, and
wherein the filtering layer is free of lines of weakness.

15. The cover element of claim 14, wherein the main layer is configured to break at a weakening of the lines of weakness when a pressure at the inner surface is greater than or equal to 5 bar and less than or equal to 15 bar.

16. The cover element of claim 14, wherein the lines of weakness penetrate the main layer to a depth greater than or equal to 50% of a thickness of the main layer and less than or equal to 100% of the thickness of the main layer.

17. The cover element of claim 14, wherein the lines of weakness extend through an entire thickness of the main layer.

18. The cover element of claim 14, wherein the waterproof layer is between the filtering layer and the inner surface of the main layer.

19. The cover element of claim 14, wherein the lines of weakness are defined by notches formed on the main layer by mechanical material removal.

20. The cover element of claim 14, wherein the lines of weakness are defined by cuts made by thermal ablation.

21. The cover element of claim 14, wherein the lines of weakness extend through the protective layer.

22. The cover element of claim 14, further comprising:
a reinforcement layer between the filtering layer and the inner surface of the main layer.

23. The cover element of claim 14, wherein the reinforcement layer is free of lines of weakness.

24. The cover element of claim 14, wherein the main layer is made of cellophane,
wherein the reinforcement layer is made of cellophane, or
wherein the main layer is made of cellophane and the reinforcement layer is made of cellophane.

25. The cover element of claim 22, wherein the main layer, the protective layer, the waterproof layer, the filtering layer, and the reinforcement layer are made of materials that are compatible with a composting process.

26. The cover element of claim 14, wherein the lines of weakness are defined by cuts made by thermal ablation using a laser.

27. The cover element of claim 22, wherein the main layer is made of cellophane,
wherein the reinforcement layer is made of cellophane, or
wherein the main layer is made of cellophane and the reinforcement layer is made of cellophane.
